(19) United States
(12) Patent Application Publication
(10) Pub. No.: US 2024/0056228 A1
(43) Pub. Date: Feb. 15, 2024

(54) NETWORK SYSTEM AND COMMUNICATION CONTROL METHOD

(71) Applicant: Fujitsu Limited, Kawasaki-shi (JP)

(72) Inventor: Taketoshi YOSHIDA, Kunitachi (JP)

(73) Assignee: Fujitsu Limited, Kawasaki-shi (JP)

(21) Appl. No.: 18/329,894

(22) Filed: Jun. 6, 2023

(30) Foreign Application Priority Data
Aug. 15, 2022 (JP) 2022-129311

(51) Int. Cl. H04L 1/1812

(52) U.S. Cl. CPC H04L 1/1816; H04L 2001/0095

(57) ABSTRACT

A network system includes nodes that form a ring network, wherein a transmission source node includes a first processor configured to divide transmission target data into a plurality of pieces of divided data, transmit the divided data in a first direction round of the ring network, and transmit redundant data in a second direction round, a first relay node includes a second processor configured to detect occurrence of a failure in a path to a transmission destination node in the ring network, and when there is un-transmitted divided data, transmit a transmission request for un-transmitted redundant data in the second direction round, and a second relay node includes a third processor configured to save at least one piece of redundant data in a memory, and when the un-transmitted redundant data is saved in the memory, transmit the un-transmitted redundant data in the second direction round toward the transmission destination node.

### CROSS-REFERENCE TO RELATED APPLICATION

This application is based upon and claims the benefit of priority of the prior Japanese Patent Application No. 2022-129311, filed on Aug. 15, 2022, the entire contents of which are incorporated herein by reference.

### FIELD

The embodiment discussed herein is related to a network system and a communication control method.

### BACKGROUND

In recent years, a network system has been developed in which a plurality of nodes capable of communicating with each other are coupled in a ring shape not via a switch to form a ring network, and data is shared among the plurality of nodes to perform communication.

As a related technique, for example, there has been proposed a technique in which, when congestion occurs in a ring network and a router in the ring network detects discarding of a packet due to the congestion, the router outputs the packet to be retransmitted in both of left and right direction rounds of the ring network.

Japanese Laid-open Patent Publication No. 2012-134582 is disclosed as related art.

### SUMMARY

According to an aspect of the embodiment, a network system includes nodes that form a ring network, the nodes includes a transmission source node, a first relay node, and a second relay node, wherein the transmission source node includes a first memory, and a first processor coupled to the first memory and the first processor configured to divide transmission target data to be transmitted to a transmission destination node included in the ring network into a plurality of pieces of divided data, transmit the plurality of pieces of divided data in a first direction round of the ring network, and transmit a plurality of pieces of redundant data, each of which corresponds to one of the plurality of pieces of divided data, in a second direction round opposite to the first direction round, the first relay node includes a second memory, and a second processor coupled to the second memory and the second processor configured to detect occurrence of a failure in a path to the transmission destination node in the ring network, and when there is un-transmitted divided data that has not been transmitted to the transmission destination node among the plurality of pieces of divided data received from the transmission source node, transmit a transmission request for un-transmitted redundant data that corresponds to the un-transmitted divided data among the plurality of pieces of redundant data, in the second direction round, and the second relay node includes a third memory, and a third processor coupled to the third memory and the third processor configured to save at least one piece of redundant data among the plurality of pieces of redundant data received from the transmission source node in the third memory, receive the transmission request, and when the un-transmitted redundant data corresponding to the transmission request is saved in the third memory, transmit the un-transmitted redundant data in the second direction round toward the transmission destination node.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a diagram illustrating an example of a network system;

FIG. 2 is a diagram illustrating an example of a configuration of a network system;

FIG. 3 is a diagram illustrating an example of functional blocks of a node;

FIG. 4 is a diagram illustrating an example of a structure of data stored in a transmission/reception buffer;

FIG. 5 is a diagram illustrating an example of an operation of a network system;

FIG. 6 is a diagram illustrating an example of an operation of a network system;

FIG. 7 is a diagram illustrating an example of an operation of a network system;

FIG. 8 is a diagram illustrating an example of an operation of a network system;

FIG. 9 is a diagram illustrating an example of an operation of a network system;

FIG. 10 is a diagram illustrating an example of an operation of a network system;

FIG. 11 is a diagram illustrating an example of an operation of a network system;

FIG. 12 is a diagram illustrating an example of an operation of a network system when a transmission request is transmitted to a transmission destination node;

FIG. 13 is a diagram illustrating an example of time-series holding states for redundant data in each node;

FIG. 14 is a diagram illustrating an example of time-series holding states for redundant data in each node;

FIG. 15 is a diagram illustrating an example of time-series holding states for redundant data in each node;

FIG. 16 is a diagram illustrating an example of a configuration of a network system;

FIG. 17 is a diagram illustrating an example of an operation sequence in a normal situation;

FIG. 18 is a diagram illustrating an example of an operation sequence in a normal situation;

FIG. 19 is a diagram illustrating an example of an operation sequence in a normal situation;

FIG. 20 is a diagram illustrating an example of an operation sequence in an abnormal situation;

FIG. 21 is a diagram illustrating an example of an operation sequence in an abnormal situation;

FIG. 22 is a flowchart when a node operates as a transmission source node;

FIG. 23 is a flowchart when a node operates as a relay node that relays divided data; and

FIG. 24 is a flowchart when a node operates as a relay node that relays redundant data.

### DESCRIPTION OF EMBODIMENT

When data is transmitted in a predetermined direction round from a transmission source node toward a transmission destination node in a ring network, a failure sometimes occurs in an intermediate path. When such a failure occurs, traditionally, a failure detection node that has detected the failure retransmits the data in the backward direction round toward the transmission destination node to avoid the failure.

However, when data is retransmitted from the failure detection node, there is a problem that a communication load grows higher due to retransmission data in a path from the failure detection node to the transmission destination node.

Hereinafter, an embodiment will be described with reference to the drawings.

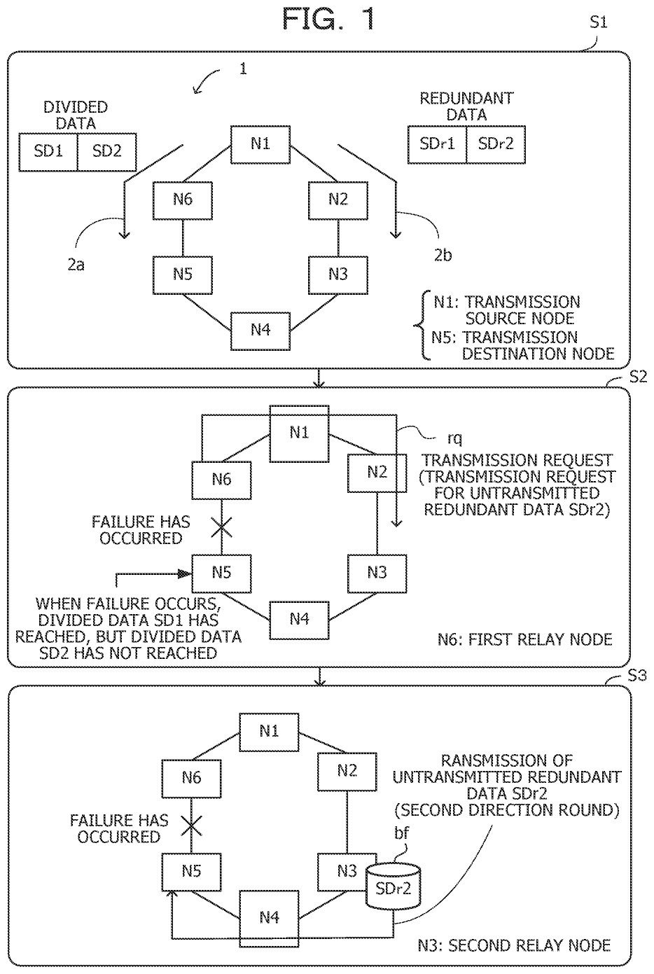

FIG. 1 is a diagram illustrating an example of a network system. A network system 1 includes a plurality of nodes N1 to N6, and the nodes N1 to N6 form a ring network. Functions of the nodes N1 to N6 are implemented by, for example, a processor (not illustrated) executing a predetermined program, and all the nodes N1 to N6 have the same function.

[Step S1] Among the nodes N1 to N6, the node N1 is assumed as a transmission source node, and the node N5 is assumed as a transmission destination node. When transmitting data to the transmission destination node N5, the transmission source node N1 divides transmission target data into a plurality of pieces of divided data SD1 and SD2 and transmits the divided data SD1 and SD2 in a first direction round 2a of the ring network.

In addition, the transmission source node N1 transmits redundant data SDr1 and SDr2 corresponding to the divided data SD1 and SD2 in a second direction round 2b opposite to the first direction round 2a. Note that the redundant data SDr1 and the redundant data SDr2 are generated, for example, by attaching a redundancy flag to each piece of the divided data SD1 and SD2, and the data contents are substantially the same.

[Step S2] It is assumed that a failure occurs in a path between the transmission destination node N5 and the relay node N6 (first relay node) in the ring network and the relay node N6 detects the failure. At this time, it is also assumed that the divided data SD1 has reached the transmission destination node N5, but the divided data SD2 has not reached the transmission destination node N5.

When the relay node N6 detects the occurrence of the failure and there is the un-transmitted divided data SD2 that has not been transmitted to the transmission destination node N5 among the divided data SD1 and SD2 received from the transmission source node N1, the relay node N6 transmits a transmission request rq for the un-transmitted redundant data SDr2 corresponding to the un-transmitted divided data SD2 in the second direction round 2b.

[Step S3] It is assumed that the relay node N3 (second relay node) has saved the redundant data SDr2 among the redundant data SDr1 and SDr2 received from the transmission source node N1, in a buffer bf. When receiving the transmission request rq, since the relay node N3 has saved the un-transmitted redundant data SDr2, the relay node N3 transmits the saved un-transmitted redundant data SDr2 in the second direction round 2b toward the transmission destination node N5. Therefore, the transmission destination node N5 may receive the redundant data SDr2 that is substantially the same as the divided data SD2 that has not been reached at the time of occurrence of the failure.

As described above, in the network system 1, the transmission source node N1 divides data, transmits the divided data in the first direction round 2a of the ring network, and also transmits the redundant data in the opposite second direction round 2b. The relay node (the relay node N3 in this example) holds the redundant data. Then, when a failure occurs, the relay node N3 transmits the un-transmitted redundant data corresponding to the un-transmitted divided data in the second direction round 2b.

Here, when a failure occurs, if the relay node N6 that has detected the failure retransmits the un-transmitted data in the second direction round 2b toward the transmission destination node N5 to avoid the failure, a communication load due to retransmission data will increase in the path from the relay node N6 to the transmission destination node N5 through the nodes N1, N2, N3, and N4.

In contrast to this, in the network system 1, as described above, since the relay node N3 retransmits the un-transmitted divided data in the second direction round 2b toward the transmission destination node N5 to avoid the failure, the path in which the communication load increases due to retransmission data is the path from the relay node N3 to the transmission destination node N5 through the node N4. Therefore, since the number of paths in which the communication load increases at the time of retransmission may be decreased, the communication load when data is retransmitted may be reduced.

<Configuration of Network System>

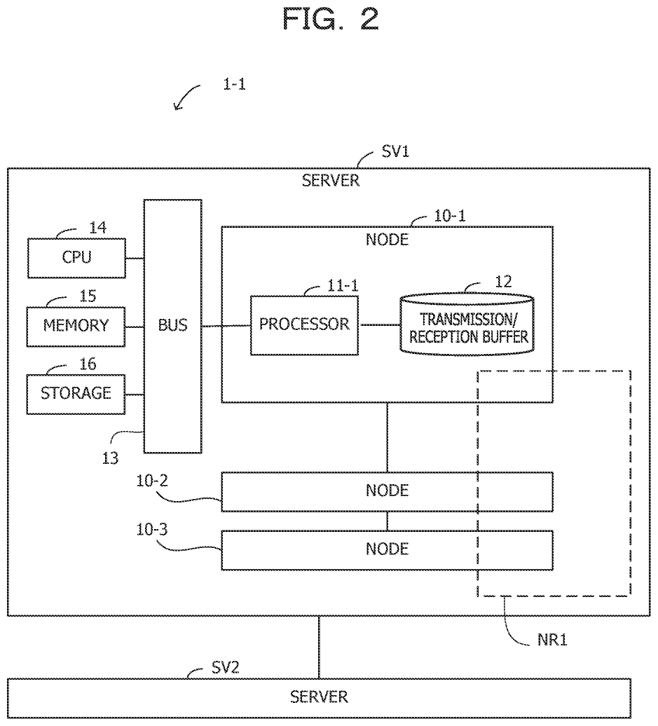

FIG. 2 is a diagram illustrating an example of a configuration of a network system. A network system 1-1 includes servers SV1 and SV2. The server SV1 includes nodes 10-1, 10-2, and 10-3, a bus 13, a central processing unit (CPU) 14, a memory 15, and a storage 16. The node 10-1 includes a processor 11-1 and a transmission/reception buffer 12.

The nodes 10-1, 10-2, and 10-3 (which will be sometimes called nodes 10 when collectively referred to) have the same functions as the nodes N1 to N6 illustrated in FIG. 1. In addition, the server SV2 also has a configuration similar to the configuration of the server SV1. The nodes 10-1, 10-2, and 10-3 in the server SV1 form a ring network NR1. Similarly, the nodes (not illustrated) in the server SV2 also form a ring network.

The node function of the nodes 10 is controlled by the processor 11-1. The CPU 14, the memory 15, and the storage 16 are coupled to the processor 11-1 via the bus 13. The bus 13 is, for example, an expansion bus such as a peripheral component interconnect express (PCIe: registered trademark).

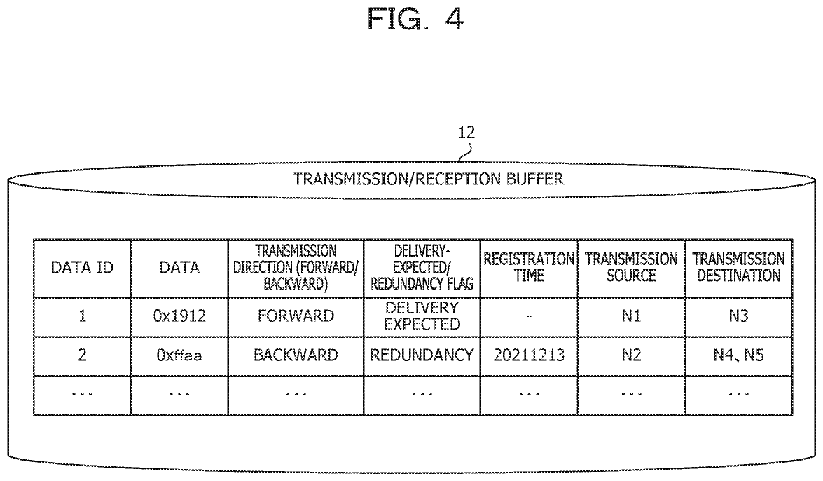

The processor 11-1 is, for example, a field programmable gate array (FPGA). Alternatively, the processor 11-1 is a CPU, a micro processing unit (MPU), a digital signal processor (DSP), or the like. The processor 11-1 may be a multiprocessor. The processor 11-1 implements functions by executing a program. The processor 11-1 may implement at least some of the functions, for example, by an electronic circuit such as an application specific integrated circuit (ASIC) or a programmable logic device (PLD). The transmission/reception buffer 12 is a memory that stores data transmitted and received by the node 10-1 and attribute information on the data (a data structure will be described later with reference to FIG. 4).

The CPU 14 controls the entire server SV1. The memory 15 is used as a main storage device of the server SV1. The memory 15 temporarily stores at least a part of an operating system (OS) program and application programs to be executed by the CPU 14 and the processor 11-1. In addition, the memory 15 stores various types of data to be used in processing by the CPU 14 and the processor 11-1. As the memory 15, for example, a volatile semiconductor storage device such as a random access memory (RAM) is used.

The storage 16 electrically or magnetically performs data writing and reading on a built-in recording medium. The storage 16 is used as an auxiliary storage device of the server SV1. The storage 16 stores the OS program, the application programs, and various types of data. Note that, as the storage 16, for example, a hard disk drive (HDD) or a solid state drive (SSD) may be used.

The server SV1 and the nodes 10 may implement processing functions by the hardware as described above. The nodes 10 included in the server SV1 implement processing functions by, for example, executing a program recorded in a computer-readable recording medium. The program in which processing contents to be executed by the nodes 10 are described may be recorded in a variety of recording media. For example, the program to be executed by the nodes 10 may be stored in the storage 16. The CPU 14 or the processor 11-1 loads at least a part of the program in the storage 16 into the memory 15 and executes the program. In addition, the program to be executed by the nodes 10 may also be recorded in a portable recording medium such as an optical disk or a memory card. The program stored in the portable recording medium may be executed after being installed in the storage 16 under the control of the CPU 14 or the processor 11-1, for example. In addition, the processor 11-1 also may read the program directly from the portable recording medium and execute the program.

<Functional Blocks>

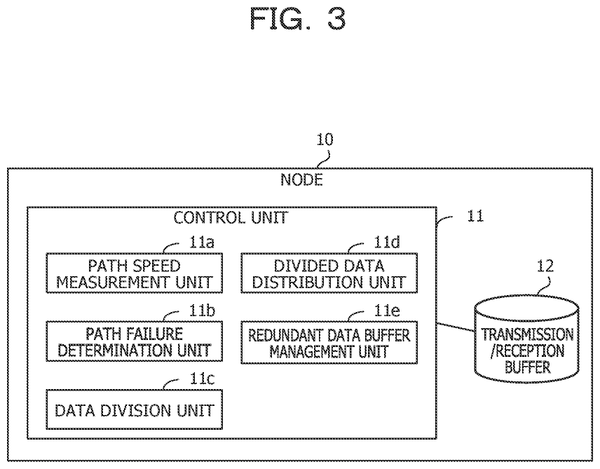

FIG. 3 is a diagram illustrating an example of functional blocks of a node. The node 10 includes a control unit 11 and the transmission/reception buffer 12. The transmission/reception buffer 12 has the function of the buffer bf in FIG. 1. The control unit 11 includes a path speed measurement unit 11a, a path failure determination unit 11b, a data division unit 11c, a divided data distribution unit 11d, and a redundant data buffer management unit 11e.

The path speed measurement unit 11a collects speed information between respective nodes in forward and backward direction rounds of the ring network and, among the collected pieces of the speed information, treats the lowest speed in the forward direction round as a communication speed in the forward direction round and the lowest speed in the backward direction round as a communication speed in the backward direction round.

When, for example, data is unable to be sent in the data transmission destination direction or the transmission time takes a certain amount or more, the path failure determination unit 11b concludes that a path failure has occurred and transmits a transmission request for the transmission scheduled data in a direction opposite to the transmission direction of the transmission scheduled data.

The data division unit 11c divides data to be transmitted, according to the block size of a data holding block in the transmission/reception buffer 12, and assigns an identifier (ID) to each piece of the divided data. The divided data distribution unit 11d transmits the data divided by the data division unit 11c in the forward and backward direction rounds, according to a communication speed ratio between the forward and backward direction rounds obtained by the path speed measurement unit 11a.

If a block in the transmission/reception buffer 12 has a free space, the redundant data buffer management unit 11e acquires and holds the transmitted redundant data (the divided data with the redundancy flag) from the head of the transmitted redundant data.

In addition, if no block has a free space, the redundant data buffer management unit lie transmits the transmitted redundant data to the next adjacent node. Note that, when all pieces of the data are received by the transmission destination node and a data reception completion notification issued from the transmission destination node is received, the redundant data buffer management unit lie deletes the redundant data held in the block in the transmission/reception buffer 12.

<Structure of Data Stored in Transmission/Reception Buffer>

FIG. 4 is a diagram illustrating an example of a structure of data stored in the transmission/reception buffer 12. The transmission/reception buffer 12 has each of items for a data ID, data, a transmission direction (forward/backward), a delivery-expected/redundancy flag, a registration time, a transmission source, and a transmission destination. The data ID denotes an ID attached to the divided data. The data denotes data contents of the divided data. The transmission direction (forward/backward) denotes the transmission direction of the divided data and indicates which of the forward direction round and the backward direction round is employed.

The delivery-expected/redundancy flag indicates which of the delivery-expected flag and the redundancy flag is attached to the divided data. Note that the delivery-expected flag is a flag attached to the divided data obtained by dividing the transmission target data to be transmitted before the redundant data is transmitted. The registration time indicates a time when the redundant data is held in a holding area. The transmission source indicates the transmission source node of the divided data. The transmission destination indicates the transmission destination node to which the divided data is to be transmitted.

<Operation of Network System>

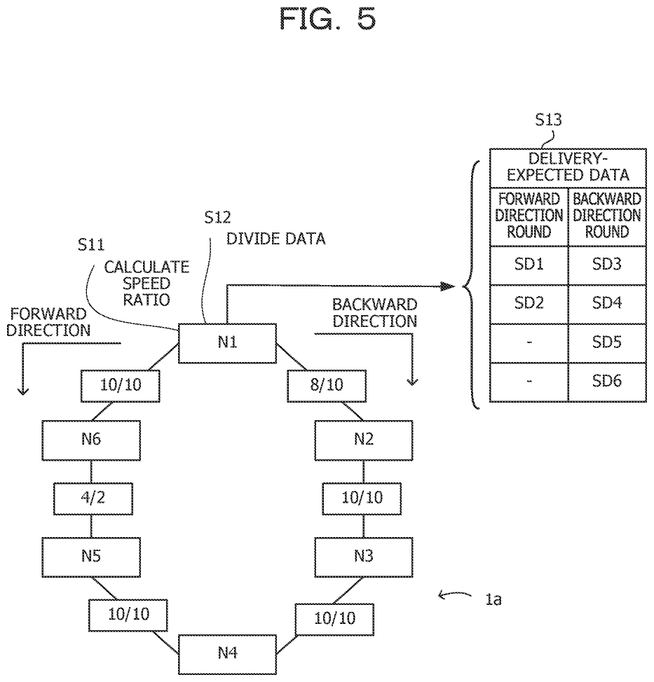

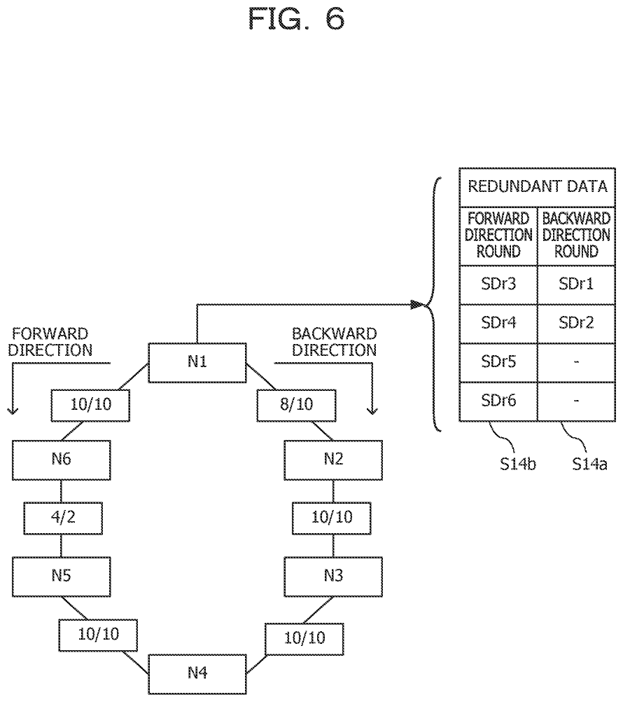

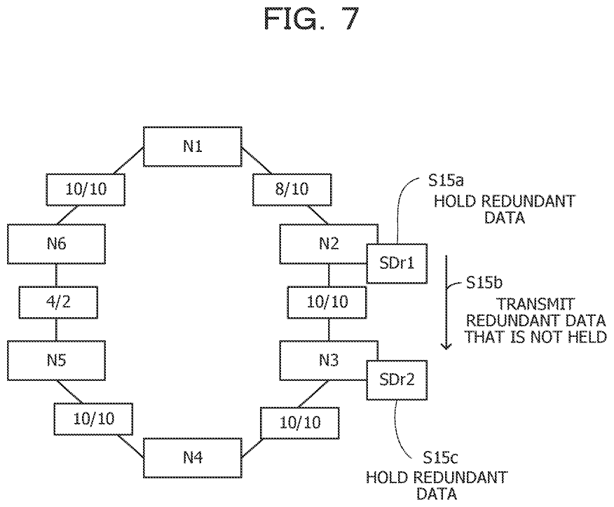

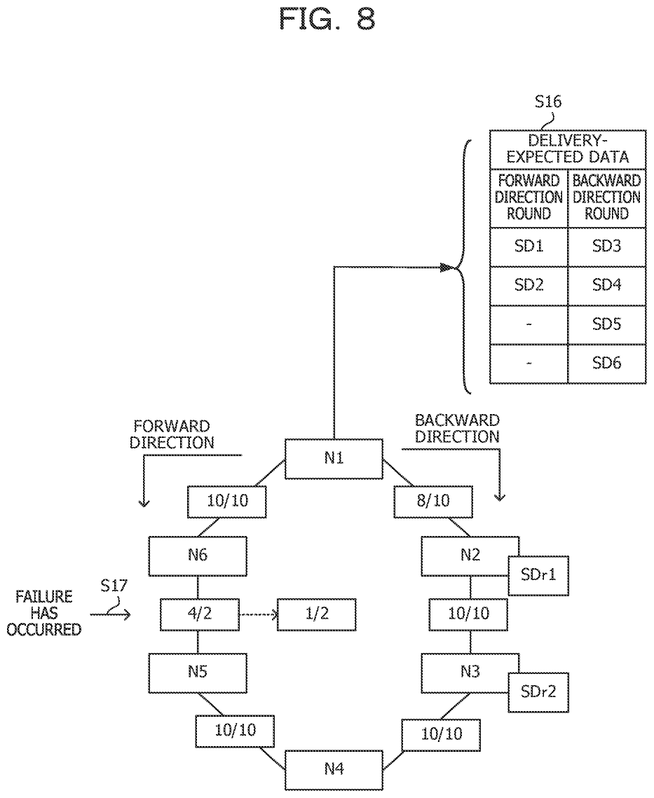

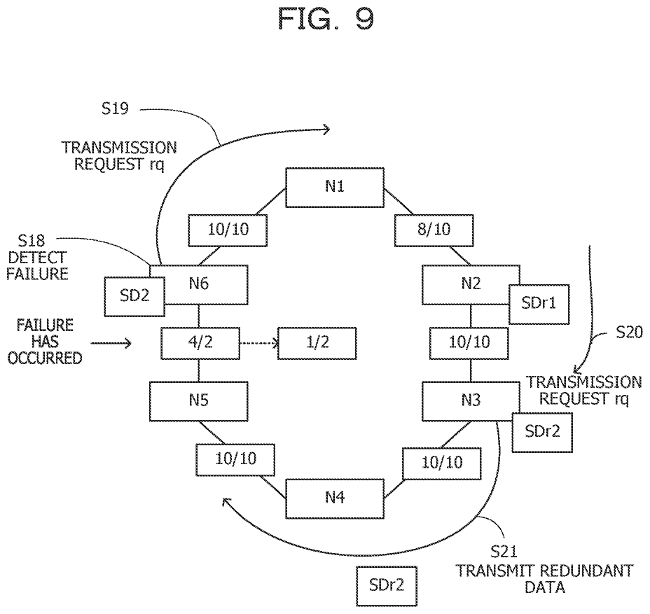

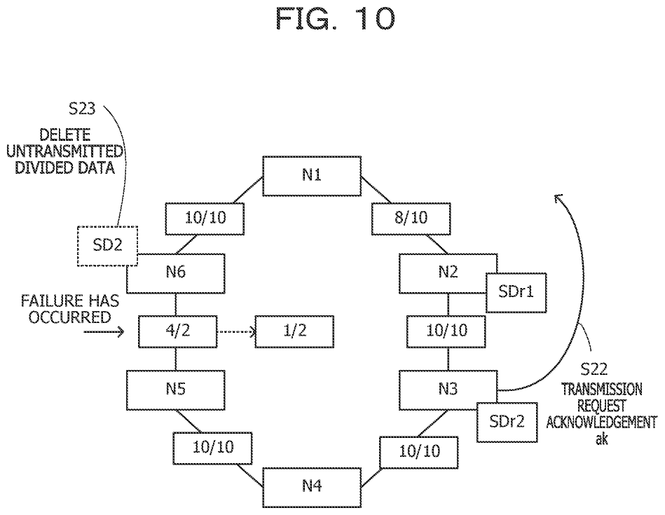

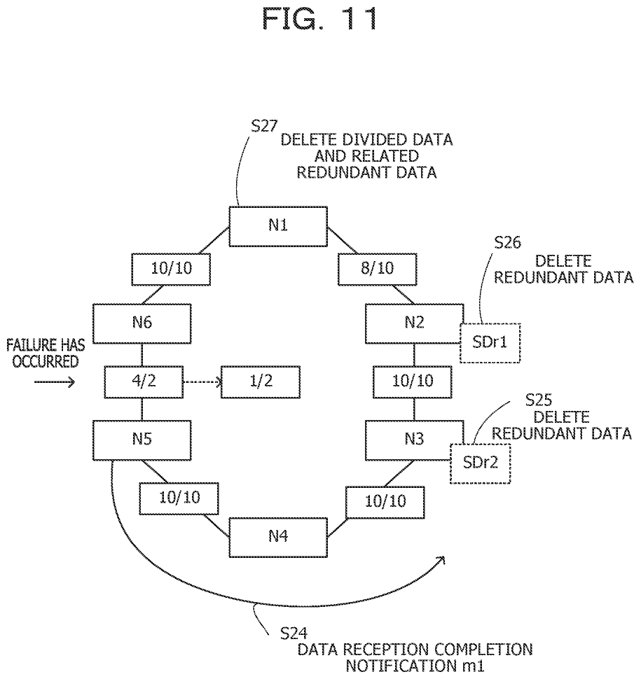

FIGS. 5 to 11 are diagrams illustrating an example of the operation of the network system. In a network system 1a, nodes N1 to N6 form a ring network, where it is assumed that the node N1 is the transmission source node and the node N5 is the transmission destination node. In addition, the numerical values on the paths between nodes indicate band values (transmission band/reception band).

For example, in the path between the nodes N1 and N2, the transmission band when the node N1 transmits data to the node N2 has 8, and the reception band when the node N1 receives data from the node N2 has 10. In addition, in the path between the nodes N2 and N3, the transmission band when the node N2 transmits data to the node N3 has 10, and the reception band when the node N2 receives data from the node N3 has 10. Furthermore, in the path between the nodes N3 and N4, the transmission band when the node N3 transmits data to the node N4 has 10, and the reception band when the node N3 receives data from the node N4 has 10.

Meanwhile, in the path between the nodes N1 to N6, the transmission band when the node N1 transmits data to the node N6 has 10, and the reception band when the node N1 receives data from the node N6 has 10. In addition, in the path between the nodes N6 and N5, the transmission band when the node N6 transmits data to the node N5 has 4, and the reception band when the node N6 receives data from the node N5 has 2. Furthermore, in the path between the nodes N5 and N4, the transmission band when the node N5 transmits data to the node N4 has 10, and the reception band when the node N5 receives data from the node N4 has 10. Note that, in the following description, the left direction round of the ring network is assumed as the forward direction round, and the right direction round is assumed as the backward direction round.

[Step S11] The node N1 that is a transmission source calculates a ratio between the load on the path to the node N5 in the forward direction round and the load on the path to the node N5 in the backward direction round. For example, the node N1 measures the data transmission speed of the forward direction round and the data transmission speed of the backward direction round to calculate the speed ratio. In this example, since the lowest transmission band in the forward direction round from the node N1 is 4 and the lowest transmission band in the backward direction round from the node N1 is 8, the speed ratio is calculated as 1:2.

[Step S12] The node N1 divides delivery-expected data to be transmitted, based on the block size in which the redundant data is to be stored in the transmission/reception buffer 12 included in each node, and generates a plurality of pieces of divided data. For example, the node N1 divides the delivery-expected data by the block size and attaches the delivery-expected flag to each piece of divided data to generate six pieces of divided data SD1 to SD6.

[Step S13] The node N1 determines the number of pieces of data to be transmitted in the forward direction round and the number of pieces of data to be transmitted in the backward direction round among the divided pieces of the delivery-expected data, based on the ratio (speed ratio) calculated in step S11.

In this example, the divided data is allocated to the forward or backward direction round according to the speed ratio and transmitted. Accordingly, since the forward direction round speed:the backward direction round speed=1:2 holds, the node N1 allocates and transmits two pieces of divided data SD1 and SD2 to the forward direction round and allocates and transmits four pieces of divided data SD3, SD4, SD5, and SD6 to the backward direction round.

In this manner, since the ratio between the load on the forward direction path and the load on the backward direction path is calculated, and the divided data of the transmission target data is transmitted in the forward and backward direction rounds based on the ratio, restraints on the communication band of the ring network may be suppressed.

[Step S14a] The node N1 attaches the redundancy flag to the divided data to generate the redundant data and transmits the redundant data. In this case, the node N1 generates redundant data SDr1 and SDr2 by attaching the redundancy flag to the divided data SD1 and SD2 and transmits the redundant data SDr1 and SDr2 in the backward direction round.

[Step S14b] The node N1 generates redundant data SDr3, SDr4, SDr5, and SDr6 by attaching the redundancy flag to the divided data SD3, SD4, SD5, and SD6 and transmits the redundant data SDr3, SDr4, SDr5, and SDr6 in the forward direction round.

Note that the node N1 may be supplied with a report of the number of empty blocks in the transmission/reception buffer 12 of each node on the path and transmit a number of pieces of the redundant data equal to the number of empty blocks.

[Step S15a] The node N2 receives the redundant data SDr1 and SDr2 transmitted from the node N1. Note that, since the redundancy flag is attached to each piece of the redundant data SDr1 and SDr2, the node N2 may recognize that the received data is the redundant data. In addition, when receiving the redundant data, the node N2 determines whether or not the redundant data holding area of the transmission/reception buffer 12 of the node N2 is available to hold the redundant data.

When the redundant data holding area of the transmission/reception buffer 12 of the node N2 has an empty block, the node N2 holds the redundant data in the empty block. Here, it is assumed that the redundant data holding area of the transmission/reception buffer 12 of the node N2 has one empty block, and the redundant data SDr1 is held in the empty block.

[Step S1513] The node N2 transmits the redundant data SDr2 that is not held in the redundant data holding area of the transmission/reception buffer 12 of the node N2, to the node N3 in the backward direction round.

[Step S15c] The node N3 receives the redundant data SDr2 transmitted from the node N2. When receiving the redundant data, the node N3 determines whether or not the redundant data holding area of the transmission/reception buffer 12 of the node N3 is available to hold the redundant data. When the redundant data holding area of the transmission/reception buffer 12 of the node N3 has an empty block, the node N3 holds the redundant data SDr2 in the empty block.

In this manner, the redundant data is held according to the empty blocks of the redundant data holding area, and the remaining redundant data that has not been saved is transmitted to another node, whereby the data storage capacity of each of the plurality of relay nodes may be efficiently used.

[Step S16] The node N1 transmits the two pieces of divided data SD1 and SD2, among the pieces of divided data obtained by dividing the delivery-expected data, to the forward direction round and transmits the four pieces of divided data SD3, SD4, SD5, and SD6, among the pieces of divided data obtained by dividing the delivery-expected data, to the backward direction round. Note that the delivery-expected flag is attached to the divided data SD1 to SD6 by the node N1, and the divided data to which the delivery-expected flag is attached is not held in the redundant data holding area of the relay node.

[Step S17] It is assumed that a failure occurs in the path between the nodes N6 and N5 after the node N6 transmits the divided data SD1 to the node N5. Such a failure includes, apart from disconnection, a case where another communication is further started between the nodes N6 and N5 and the transmission band from the node N6 to the node N5 is narrowed from 4 to 1, for example. Such a case where the reduction of band arises and the communication quality is deteriorated may also be regarded as a failure.

[Step S18] The node N6 detects that a failure has occurred in the path between the nodes N6 and N5.

[Step S19] The node N6 generates a transmission request rq for the redundant data SDr2 corresponding to the divided data SD2 that has not reached the node N5 and transmits this transmission request rq in the backward direction round. Note that the message of the transmission request rq includes, for example, at least an ID of the dispatching source node of the message and an ID of the un-transmitted redundant data targeted by the transmission request.

[Step S20] The node N2 receives the transmission request rq transmitted from the node N6 through the node N1, but does not hold the redundant data SDr2 in the redundant data holding area of the transmission/reception buffer 12 of the node N2. Accordingly, the node N2 relays and transmits the transmission request rq in the backward direction round.

[Step S21] The node N3 receives the transmission request rq transmitted from the node N2. Since the node N3 holds the redundant data SDr2 in the redundant data holding area of the transmission/reception buffer 12 of the node N3, the node N3 transmits the redundant data SDr2 in the backward direction round. Note that the node N3 stops the relay transmission of the transmission request rq in the backward direction round.

[Step S22] After transmitting the redundant data SDr2 targeted by the transmission request in the backward direction round, the node N3 transmits a transmission request acknowledgement ak in the forward direction round opposite to the direction in which the transmission request rq has been transmitted. The transmission request acknowledgement ak is relayed by the nodes N2 and N1 and transmitted to the node N6. Note that the message of the transmission request acknowledgement ak includes, for example, an ID of the dispatching source node of the message and the ID of the redundant data transmitted based on the transmission request rq.

[Step S23] When receiving the transmission request acknowledgement ak, the node N6 deletes the un-transmitted divided data SD2. In this manner, by receiving the transmission request acknowledgement ak indicating that the redundant data SDr2 corresponding to the un-transmitted divided data SD2 has been transmitted from another node, the node N6 may delete the divided data SD2 that no longer has to be transmitted from the node N6 and may secure a free space of the data storage capacity.

[Step S24] The node N5 receives the redundant data SDr2 that is substantially the same as the divided data SD2 that has not been delivered, from the node N3. Since the node N5 recognizes in advance the delivery-expected data that is supposed to be received, when recognizing the reception of all pieces of the delivery-expected data, the node N5 transmits a data reception completion notification m1 in the forward and backward direction rounds. Note that, when the failure occurrence location is recognized, transmission may be performed in a direction in which the failure occurrence location is avoided (the forward direction round in this example).

[Step S25] When receiving the data reception completion notification m1, the node N3 deletes the redundant data SDr2 held in the redundant data holding area of the transmission/reception buffer 12 of the node N3. In addition, the node N3 relays and transmits the data reception completion notification m1 to the node N2.

[Step S26] When receiving the data reception completion notification m1, the node N2 deletes the redundant data SDr1 held in the redundant data holding area of the transmission/reception buffer 12 of the node N2. In addition, the node N2 relays and transmits the data reception completion notification m1 to the node N1.

[Step S27] When receiving the data reception completion notification m1, the node N1 deletes the divided data generated by dividing the delivery-expected data and the related redundant data.

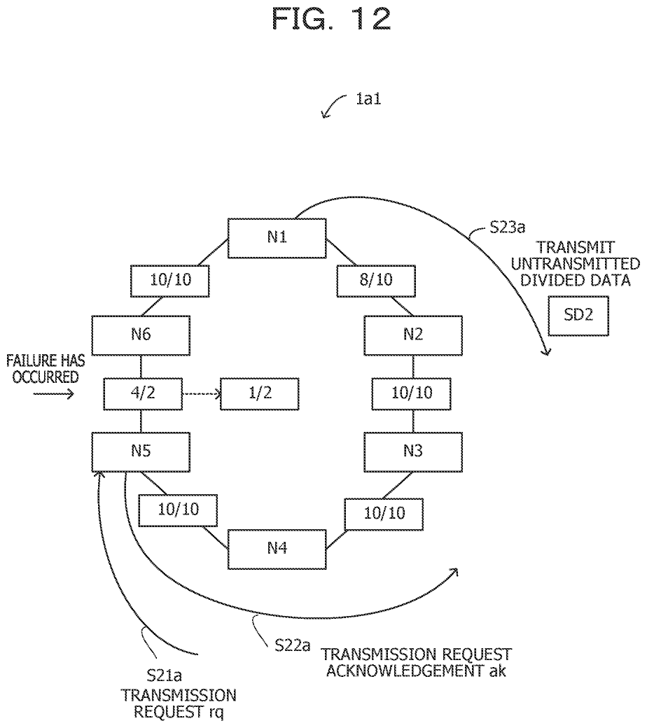

FIG. 12 is a diagram illustrating an example of an operation of a network system when a transmission request is transmitted to a transmission destination node. In a network system 1a1, it is assumed that the redundant data holding area of the transmission/reception buffer 12 of each of nodes N2, N3, and N4 has no empty block.

[Step S21a] Since the redundant data holding area of the transmission/reception buffer 12 of each of the nodes N2, N3, and N4 has no empty block, the redundant data SDr2 is not saved in any of the nodes N2, N3, and N4, and the transmission request rq is transmitted to the node N5.

[Step S22a] When receiving the transmission request rq, the node N5 transmits the transmission request acknowledgement ak in the forward direction round in which the failure is avoided, toward the node N1.

[Step S23a] When receiving the transmission request acknowledgement ak transmitted from the node N5, the node N1 as the transmission source transmits the un-transmitted divided data SD2 in the backward direction round toward the node N5.

Here, when the un-transmitted data is retransmitted toward the node N5 from the node N6 that has detected a failure, a communication load due to retransmission data will increase in the path from the node N6 to the node N5 through the nodes N1, N2, N3, and N4.

On the other hand, in the network system 1a1, even when the redundant data SDr2 is not saved in any of the nodes N2, N3, and N4 in the ring network except for the nodes N1 and N5, the un-transmitted divided data SD2 is transmitted to the node N5 from the node N1 that is the transmission source.

For this reason, the path in which a communication load due to retransmission data increases is the path from the node N1 to the node N5 through the nodes N2, N3, and N4. Therefore, since the number of paths in which the communication load increases at the time of retransmission may be decreased (in this example, the number of paths may be lessened by one), the communication load when data is retransmitted may be reduced.

<Time-Series Holding States for Redundant Data>

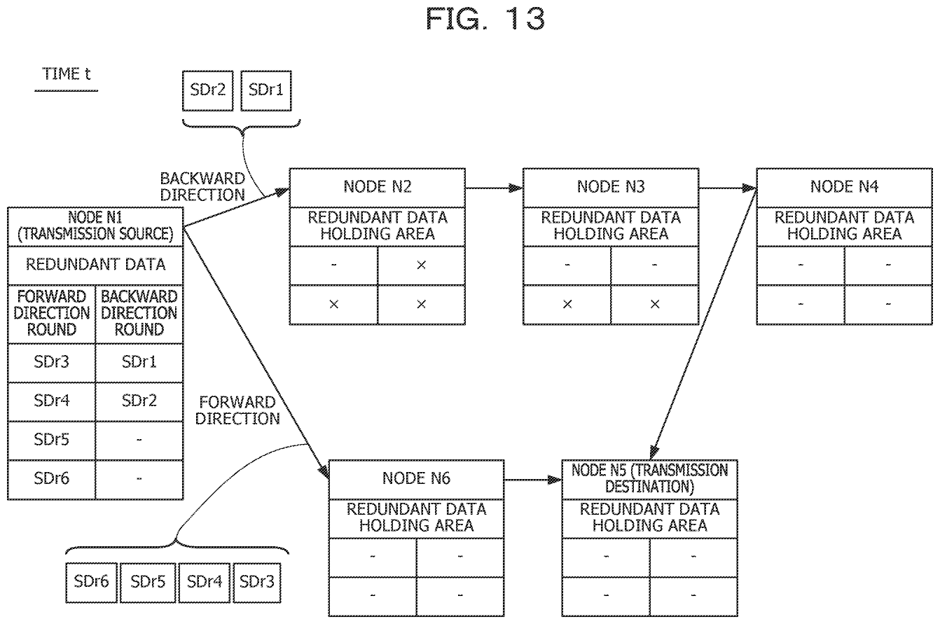

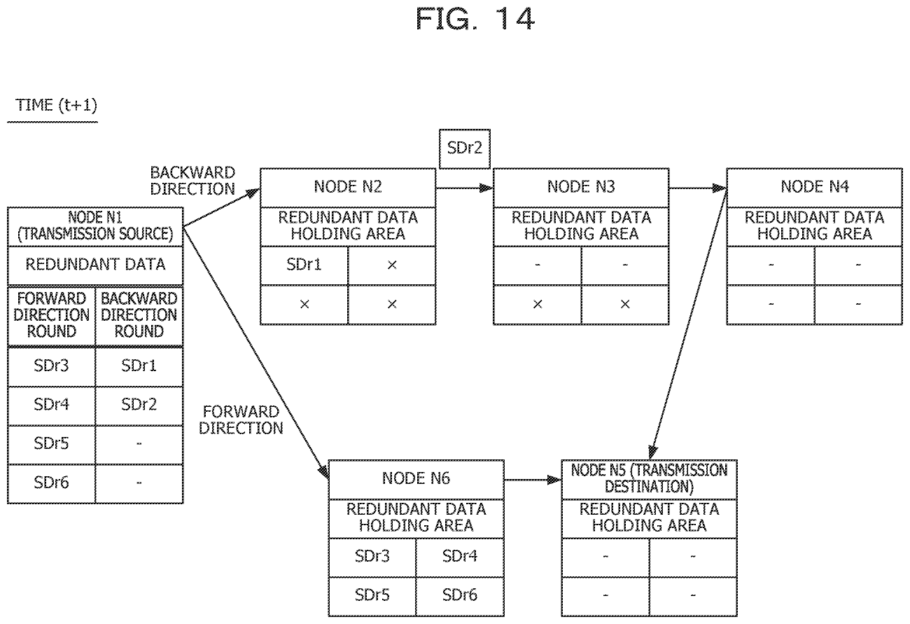

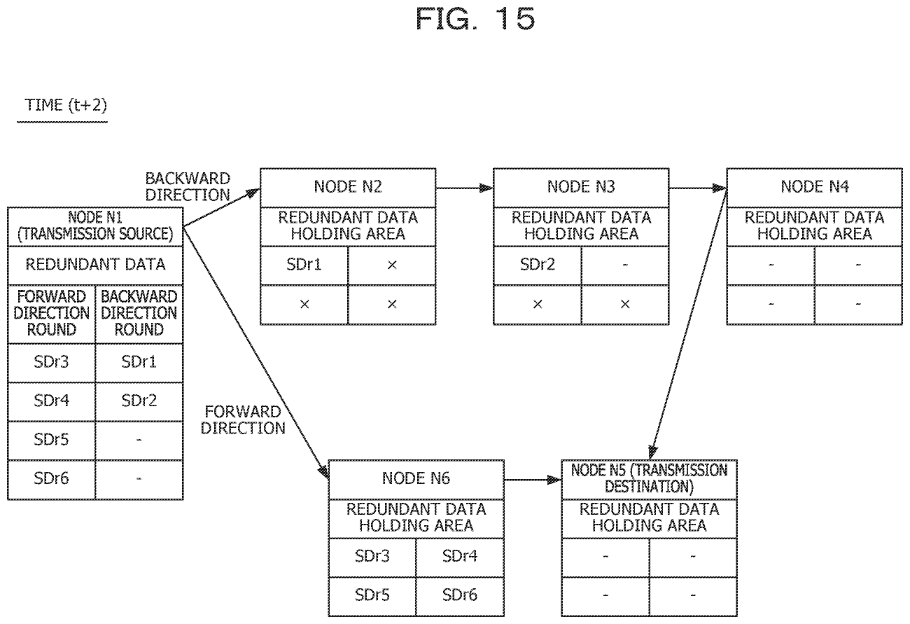

FIGS. 13 to 15 are diagrams illustrating examples of time-series holding states for the redundant data in each node. In the network system is in which the nodes N1 to N6 are coupled in a ring shape, it is assumed that the redundant data holding area of the transmission/reception buffer 12 included in each of the nodes N2 to N6 is made up of four blocks. Note that, in the drawing, “-” in the block of the redundant data holding area indicates that the block is empty, and “x” indicates that the block is not empty.

[Time t] The node N1 as the transmission source transmits the redundant data SDr3, SDr4, SDr5, and SDr6 in the forward direction round of the ring network toward the node N5 as the transmission destination and transmits the redundant data SDr1 and SDr2 in the backward direction round of the ring network toward the node N5.

[Time (t+1)] In the backward direction round, since the node N2 has one empty block in the redundant data holding area of the transmission/reception buffer 12 of the node N2, the redundant data SDr1 that has reached the node N2 first is held in this empty block. In addition, the redundant data SDr2 that is not held in the node N2 is transmitted to the node N3 located adjacent.

In the forward direction round, since the node N6 has four empty blocks in the redundant data holding area of the transmission/reception buffer 12 of the node N6, the redundant data SDr3, SDr4, SDr5, and SDr6 that have reached the node N6 are held in these empty blocks.

[Time (t+2)] In the backward direction round, since the node N3 has two empty blocks in the redundant data holding area of the transmission/reception buffer 12 of the node N3, the redundant data SDr2 transmitted to the node N3 from the node N2 is held in one empty block among the two empty blocks.

<Operation Sequence in Normal Situation>

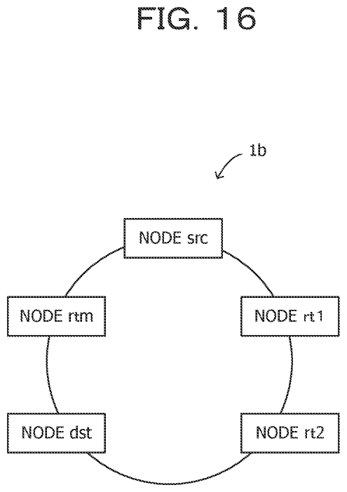

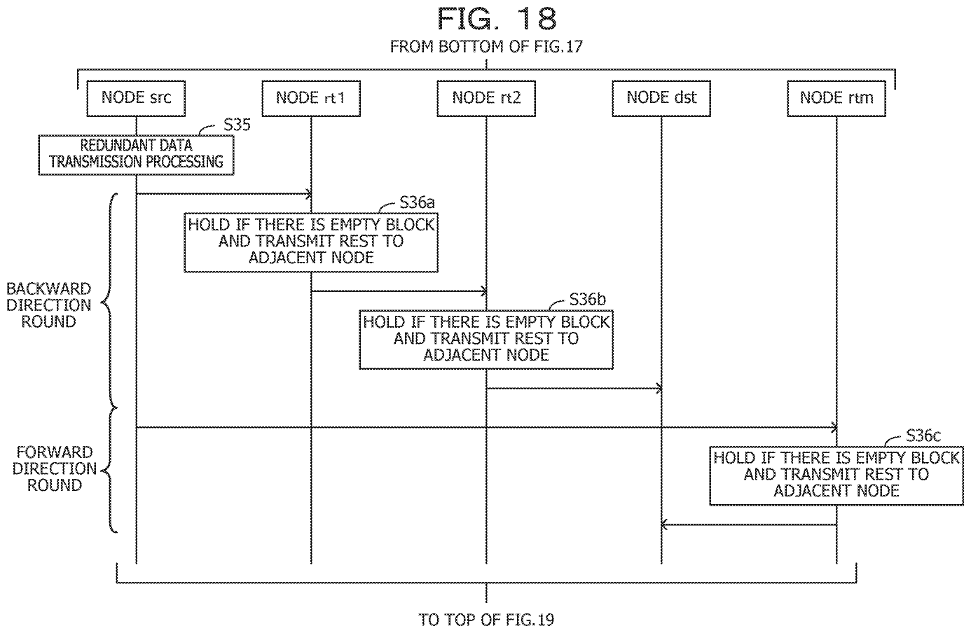

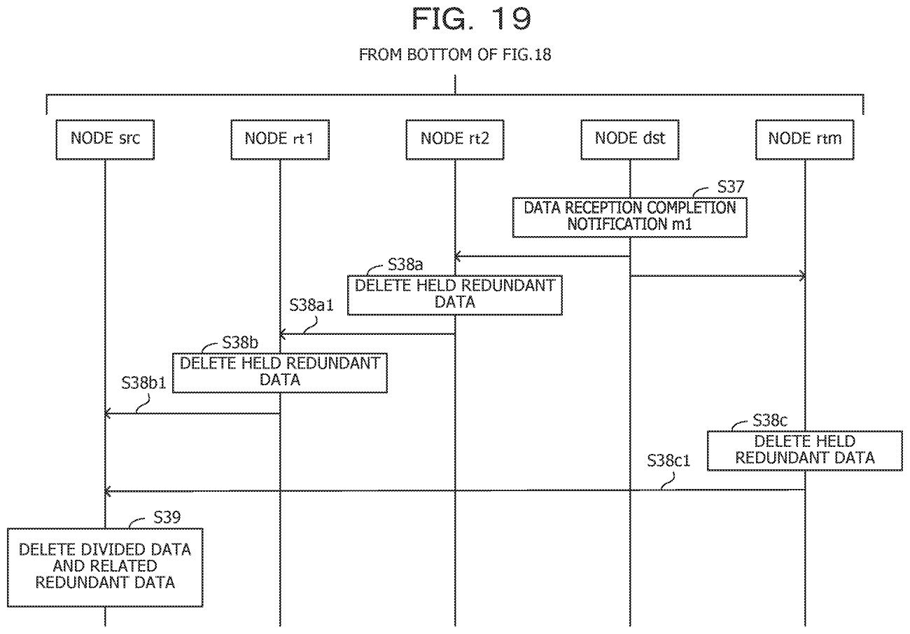

Next, an operation sequence in a normal situation of a network system will be described with reference to FIGS. 16 to 19. FIG. 16 is a diagram illustrating an example of a configuration of a network system. A network system 1b includes a node src, a node rt1, a node rt2, a node rtm, and a node dst to form a ring network as illustrated in FIG. 16. The node src is a transmission source node, and the node dst is a transmission destination node. The nodes rt1, rt2, and rtm are relay nodes.

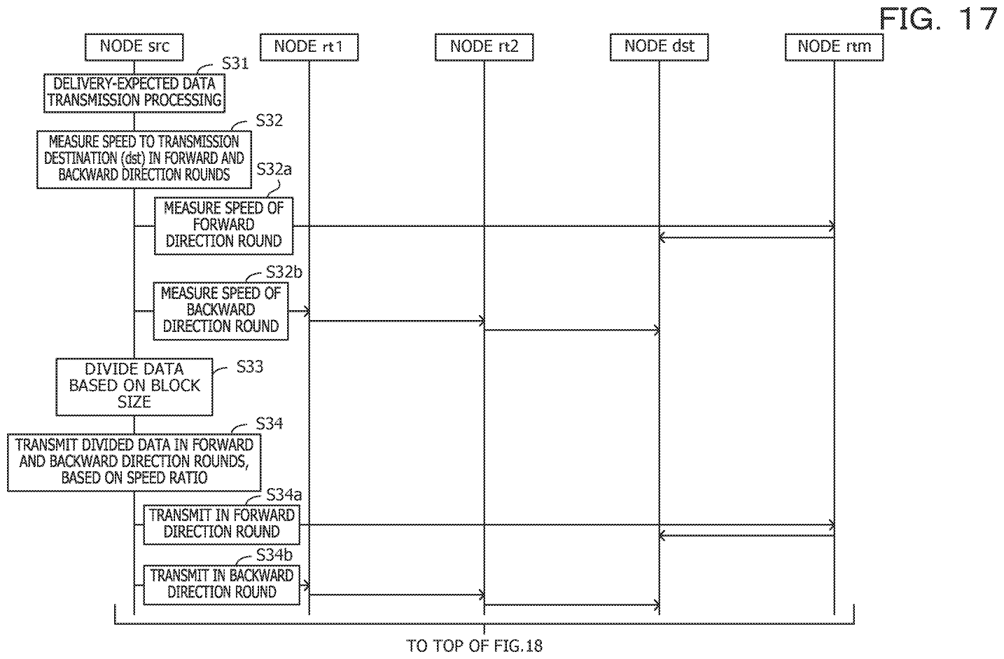

FIGS. 17 to 19 are diagrams illustrating an example of the operation sequence in a normal situation. An operation sequence when no failure has occurred in the network system 1b is illustrated.

[Step S31] The node src starts transmission processing for delivery-expected data toward the node dst.

[Step S32] The node src starts measurement of the speed of data transmission to the node dst in the forward and backward direction rounds.

[Step S32a] The node src measures the speed of data transmission to the node dst in the forward direction round. In this case, the speed of data transmission from the node src to the node rtm is measured, and the speed of data transmission from the node rtm to the node dst is measured.

[Step S32b] The node src measures the speed of data transmission to the node dst in the backward direction round. In this case, the speed of data transmission from the node src to the node rt1 is measured, the speed of data transmission from the node rt1 to the node rt2 is measured, and furthermore, the speed of data transmission from the node rt2 to the node dst is measured.

[Step S33] The node src divides the delivery-expected data to be transmitted, based on the block size of the redundant data holding area of the transmission/reception buffer 12 included in each node to generate a plurality of pieces of divided data.

[Step S34] The node src calculates a speed ratio between the speed in the forward direction round and the speed in the backward direction round and allocates the divided data supposed to be transmitted in the forward direction round and the divided data supposed to be transmitted in the backward direction round, based on the speed ratio. Then, transmission of the divided data for the forward direction round and the divided data for the backward direction round is started.

[Step S34a] The node src transmits the divided data allocated to the forward direction round according to the speed ratio, toward the node dst. The divided data for the forward direction round at the node src is transmitted to the node dst through the node rtm.

[Step S34b] The node src transmits the divided data allocated to the backward direction round according to the speed ratio, toward the node dst. The divided data for the backward direction round at the node src is transmitted to the node dst through the nodes rt1 and rt2.

[Step S35] The node src attaches the redundancy flag to the divided data generated in step S34 to generate redundant data and starts transmission processing for the redundant data.

In this case, the node src transmits the redundant data generated by attaching the redundancy flag to the divided data for the forward direction round, in the backward direction round, and transmits the redundant data generated by attaching the redundancy flag to the divided data for the backward direction round, in the forward direction round.

[Step S36a] When receiving the redundant data transmitted from the node src, if the redundant data holding area of the transmission/reception buffer 12 of the node rt1 has an empty block, the node rt1 holds the redundant data in the empty block. In addition, the node rt1 transmits the redundant data that is not held in the redundant data holding area of the transmission/reception buffer 12 of the node rt1 to the node rt2.

[Step S36b] When receiving the redundant data transmitted from the node rt1, if the redundant data holding area of the transmission/reception buffer 12 of the node rt2 has an empty block, the node rt2 holds the redundant data in the empty block. In addition, the node rt2 transmits the redundant data that is not held in the redundant data holding area of the transmission/reception buffer 12 of the node rt2 to the node dst.

[Step S36c] When receiving the redundant data transmitted from the node src, if the redundant data holding area of the transmission/reception buffer 12 of the node rtm has an empty block, the node rtm holds the redundant data in the empty block. In addition, the node rtm transmits the redundant data that is not held in the redundant data holding area of the transmission/reception buffer 12 of the node rtm to the node dst.

[Step S37] Since the node dst recognizes in advance the delivery-expected data supposed to be received, when recognizing the reception of all pieces of the delivery-expected data, the node dst transmits a data reception completion notification m1 in both of the forward and backward direction rounds.

[Step S38a] When receiving the data reception completion notification m1, the node rt2 deletes the redundant data held in the redundant data holding area of the transmission/reception buffer 12 of the node rt2.

[Step S38a1] The node rt2 transmits the data reception completion notification m1 to the node rt1.

[Step S38b] When receiving the data reception completion notification m1, the node rt1 deletes the redundant data held in the redundant data holding area of the transmission/reception buffer 12 of the node rt1.

[Step S38b1] The node rt1 transmits the data reception completion notification m1 to the node src.

[Step S38c] When receiving the data reception completion notification m1, the node rtm deletes the redundant data held in the redundant data holding area of the transmission/reception buffer 12 of the node rtm.

[Step S38c1] The node rtm transmits the data reception completion notification to the node src.

[Step S39] When receiving the data reception completion notification m1, the node src deletes the divided data generated by dividing the delivery-expected data and the related redundant data. In this manner, since the relay node deletes the held redundant data when receiving the data reception completion notification m1, a free capacity of the data storage capacity may be secured.

<Operation Sequence in Abnormal Situation>

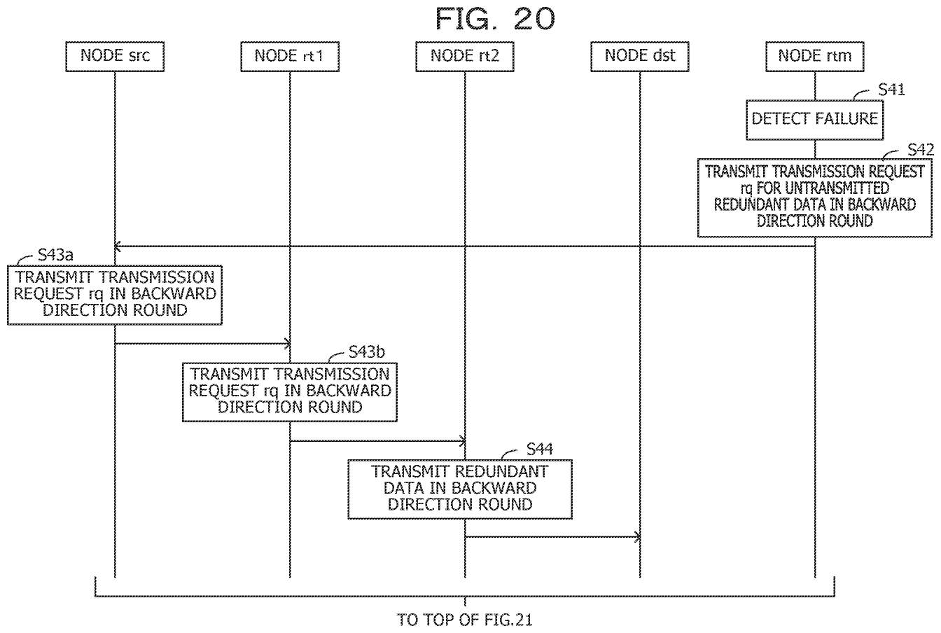

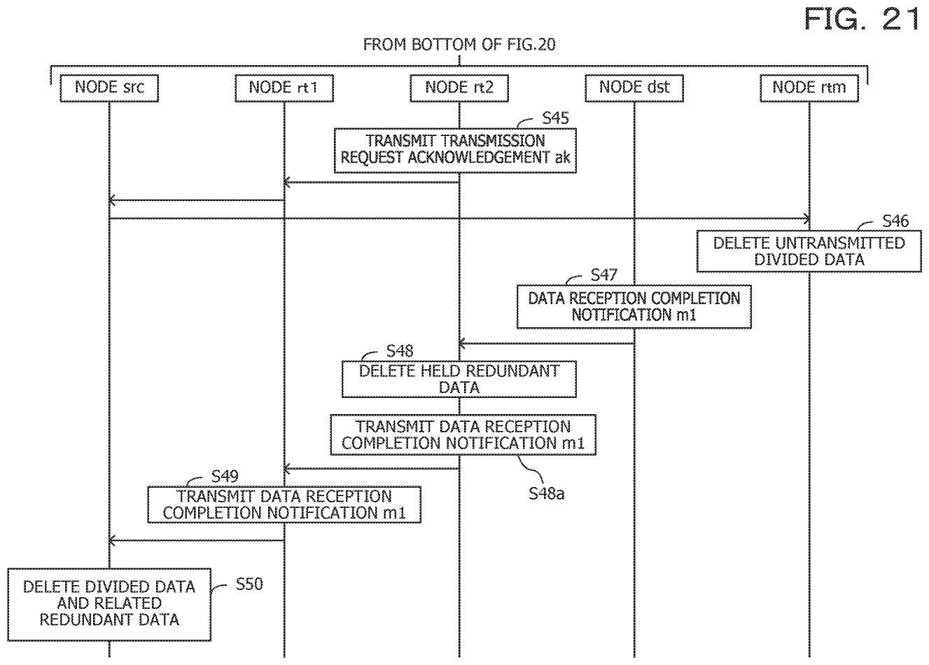

Next, an operation sequence in an abnormal situation of the network system will be described with reference to FIGS. 20 and 21. An operation sequence when a failure has occurred in a path between the nodes rtm and dst in the network system 1b illustrated in FIG. 16 is illustrated.

FIGS. 20 and 21 are diagrams illustrating an example of the operation sequence in an abnormal situation. It is assumed that redundant data to be retransmitted is held in the node rt2.

[Step S41] The node rtm detects that a failure has occurred in the path between the nodes rtm and dst.

[Step S42] The node rtm generates a transmission request rq for the un-transmitted redundant data to be retransmitted corresponding to the un-transmitted divided data that has not been transmitted to the node dst and transmits this transmission request rq in the backward direction round.

[Step S43a] When receiving the transmission request rq transmitted from the node rtm, the node src transmits this transmission request rq in the backward direction round.

[Step S43b] The node rt1 receives the transmission request rq transmitted from the node src. When the node rt1 does not hold the redundant data targeted by the transmission request, in the redundant data holding area of the transmission/reception buffer 12 of the node rt1, the node rt1 transmits the transmission request rq in the backward direction round.

[Step S44] The node rt2 receives the transmission request rq transmitted from the node rt1. When the node rt2 holds the redundant data targeted by the transmission request, in the redundant data holding area of the transmission/reception buffer 12 of the node rt2, the node rt2 transmits the redundant data targeted by the transmission request in the backward direction round.

[Step S45] After transmitting the redundant data targeted by the transmission request in the backward direction round, the node rt2 transmits the transmission request acknowledgement ak in the forward direction round (the reverse direction to the direction in which the transmission request rq has been transmitted). The transmission request acknowledgement ak is relayed by the nodes rt1 and src and transmitted to the node rtm.

[Step S46] When receiving the transmission request acknowledgement ak, the node rtm deletes the un-transmitted divided data.

[Step S47] The node dst receives the redundant data corresponding to the divided data that has not reached, from the node rt2. Since the node dst recognizes in advance the delivery-expected data supposed to be received, when recognizing the reception of all pieces of the delivery-expected data, the node dst transmits a data reception completion notification m1 in a direction in which the failure occurrence location is avoided (the forward direction round in this example).

[Step S48] When receiving the data reception completion notification m1, the node rt2 deletes the redundant data held in the redundant data holding area of the transmission/reception buffer 12 of the node rt2.

[Step S48a] The node rt2 transmits the data reception completion notification m1 transmitted from the node dst to the node rt1.

[Step S49] The node rt1 transmits the data reception completion notification m1 transmitted from the node rt2 to the node src.

[Step S50] When receiving the data reception completion notification m1, the node src deletes the divided data generated by dividing the delivery-expected data and the related redundant data.

<Flowchart>

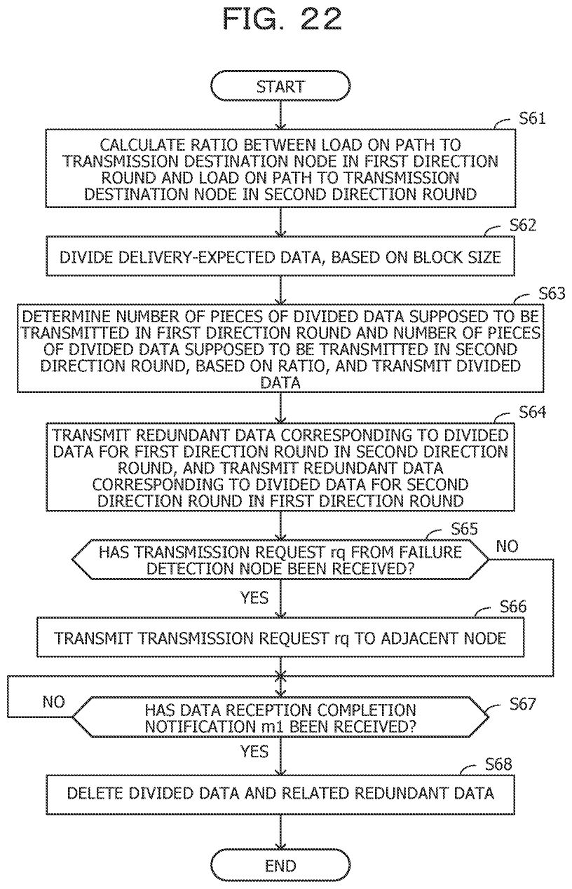

Next, operations of the node 10 in the ring network forming the network system will be described with reference to a flowchart. FIG. 22 is a flowchart when the node operates as a transmission source node.

[Step S61] The control unit 11 calculates the ratio between the load on the path to the transmission destination node in the first direction round and the load on the path to the transmission destination node in the second direction round.

[Step S62] The control unit 11 divides the delivery-expected data to be transmitted, based on the block size of the redundant data holding area of the transmission/reception buffer 12 included in each node to generate a plurality of pieces of divided data.

[Step S63] The control unit 11 determines the number of pieces of divided data supposed to be transmitted in the first direction round and the number of pieces of divided data supposed to be transmitted in the second direction round, based on the ratio calculated in step S61. The control unit 11 transmits the divided data.

[Step S64] The control unit 11 generates redundant data by attaching the redundancy flag to each piece of the divided data, transmits the redundant data corresponding to the divided data for the first direction round in the second direction round, and transmits the redundant data corresponding to the divided data for the second direction round in the first direction round.

[Step S65] The control unit 11 determines whether or not the transmission request rq transmitted from a failure detection node that has detected a failure has been received. When the transmission request rq has been received, the processing proceeds to step S66, and when the transmission request rq has not been received, the processing proceeds to step S67.

[Step S66] The control unit 11 transmits the transmission request rq to an adjacent node.

[Step S67] The control unit 11 determines whether or not the data reception completion notification m1 has been received. When the data reception completion notification m1 has been received, the processing proceeds to step S68, and when the data reception completion notification m1 has not been received, the processing in step S67 is repeated.

[Step S68] When receiving the data reception completion notification m1, the control unit 11 deletes the divided data generated by dividing the delivery-expected data and the related redundant data.

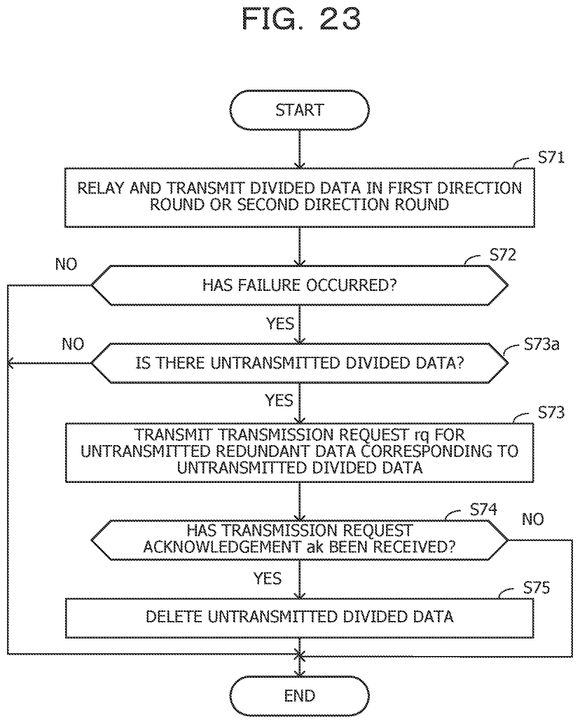

FIG. 23 is a flowchart when the node operates as a relay node that relays the divided data.

[Step S71] The control unit 11 relays and transmits the divided data in the first direction round or the second direction round.

[Step S72] The control unit 11 determines whether or not the occurrence of a failure has been detected. When the occurrence of a failure has been detected, the processing proceeds to step S73a, and when the occurrence of a failure has not been detected, the processing ends.

[Step S73a] The control unit 11 determines whether or not un-transmitted divided data is held. When un-transmitted divided data is held, the processing proceeds to step S73, and when no un-transmitted divided data is held, the processing ends.

[Step S73] When there is un-transmitted divided data that has not been transmitted to the transmission destination node due to the occurrence of a failure, the control unit 11 transmits the transmission request rq for un-transmitted redundant data corresponding to the un-transmitted divided data. In this case, when the failure is detected in the path in the first direction round, the transmission request rq is transmitted in the second direction round.

[Step S74] The control unit 11 determines whether or not the transmission request acknowledgement ak has been received. When the transmission request acknowledgement ak has been received, the processing proceeds to step S75, and when the transmission request acknowledgement ak has not been received, the processing ends.

[Step S75] When recognizing that the un-transmitted redundant data has been transmitted to the transmission destination node from another relay node, by receiving the transmission request acknowledgement ak, the control unit 11 deletes the held un-transmitted divided data.

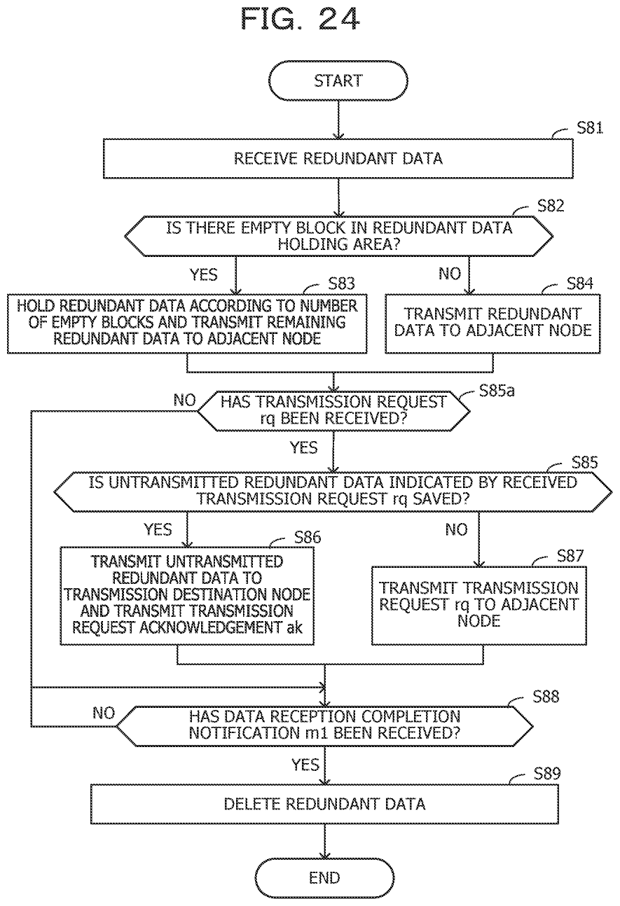

FIG. 24 is a flowchart when the node operates as a relay node that relays the redundant data.

[Step S81] The control unit 11 receives the redundant data transmitted from the transmission source node.

[Step S82] The control unit 11 determines whether or not there is an empty block in the redundant data holding area of the transmission/reception buffer 12 of its own. When there is an empty block, the processing proceeds to step S83, and when there is no empty block, the processing proceeds to step S84.

[Step S83] The control unit 11 holds the redundant data according to the number of empty blocks and transmits the remaining redundant data that is not held, to the adjacent node.

[Step S84] The control unit 11 transmits the redundant data to the adjacent node.

[Step S85a] The control unit 11 determines whether or not the transmission request rq has been received. When the transmission request rq has been received, the processing proceeds to step S85, and when the transmission request rq has not been received, the processing proceeds to step S88.

[Step S85] When receiving the transmission request rq, the control unit 11 determines whether or not the un-transmitted redundant data indicated by the received transmission request rq is saved. When the un-transmitted redundant data is saved, the processing proceeds to step S86, and when the un-transmitted redundant data is not saved, the processing proceeds to step S87.

[Step S86] The control unit 11 transmits the un-transmitted redundant data toward the transmission destination node and transmits the transmission request acknowledgement ak. At this time, when the transmission request rq has been transmitted in the second direction round, the un-transmitted redundant data is transmitted in the second direction round, and the transmission request acknowledgement ak is transmitted in the first direction round.

[Step S87] The control unit 11 transmits the transmission request rq to the adjacent node.

[Step S88] The control unit 11 determines whether or not the data reception completion notification m1 has been received. When the data reception completion notification m1 has been received, the processing proceeds to step S89, and when the data reception completion notification m1 has not been received, the processing in step S88 is repeated.

[Step S89] The control unit 11 deletes the redundant data held in the redundant data holding area of the transmission/reception buffer 12 of its own.

The network system and the node of the embodiment described above may be implemented by a computer. In this case, a program in which processing contents of functions that the node is supposed to have are described is provided. This program is executed in the computer, whereby the processing functions described above are implemented in the computer.

The program in which the processing contents are described may be recorded in a computer-readable recording medium. Examples of the computer-readable recording medium include a magnetic storage unit, an optical disk, a magneto-optical recording medium, and a semiconductor memory. Examples of the magnetic storage unit include a hard disk device (HDD), a flexible disk (FD), and a magnetic tape. Examples of the optical disk include a compact disk read only memory (CD-ROM)/read write (RW). Examples of the magneto-optical recording medium include a magneto optical disk (MO).

In a case of distributing the program, for example, portable recording media such as CD-ROMs in which that program is recorded are sold. Alternatively, it is also possible to store the program in a storage unit of a server computer and transfer the stored program to another computer from the server computer via a network.

The computer that executes the program stores, for example, the program recorded in the portable recording medium or the program transferred from the server computer in a storage unit of its own. Then, the computer reads the program from the storage unit of its own and executes processing in accordance with the program. Note that the computer may also read the program directly from the portable recording medium and execute processing in accordance with the read program.

In addition, the computer may also successively execute processing in accordance with the received program each time the program is transferred from the server computer coupled via the network. Furthermore, at least a part of the processing functions described above may be implemented by an electronic circuit such as a DSP, an ASIC, or a PLD.

While the embodiment has been exemplified thus far, the configuration of each unit illustrated in the embodiment may be replaced with another configuration having a similar function. Furthermore, any other components and steps may be added. Moreover, any two or more configurations (features) of the embodiment described above may be combined.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A network system comprising nodes that form a ring network, the nodes including:
a transmission source node;
a first relay node; and
a second relay node,
wherein
the transmission source node includes:
a first memory; and
a first processor coupled to the first memory and the first processor configured to:
divide transmission target data to be transmitted to a transmission destination node included in the ring network into a plurality of pieces of divided data;
transmit the plurality of pieces of divided data in a first direction round of the ring network; and
transmit a plurality of pieces of redundant data, each of which corresponds to one of the plurality of pieces of divided data, in a second direction round opposite to the first direction round,
the first relay node includes:
a second memory; and
a second processor coupled to the second memory and the second processor configured to:
detect occurrence of a failure in a path to the transmission destination node in the ring network; and
when there is un-transmitted divided data that has not been transmitted to the transmission destination node among the plurality of pieces of divided data received from the transmission source node, transmit a transmission request for un-transmitted redundant data that corresponds to the un-transmitted divided data among the plurality of pieces of redundant data, in the second direction round, and
the second relay node includes:
a third memory; and
a third processor coupled to the third memory and the third processor configured to:
save at least one piece of redundant data among the plurality of pieces of redundant data received from the transmission source node in the third memory;
receive the transmission request; and
when the un-transmitted redundant data corresponding to the transmission request is saved in the third memory, transmit the un-transmitted redundant data in the second direction round toward the transmission destination node.

2. The network system according to claim 1, wherein
the third processor is further configured to:
when the un-transmitted redundant data corresponding to the transmission request is saved in the third memory, transmit a transmission request acknowledgement in the first direction round toward the first relay node, and
the second processor is further configured to:
when receiving the transmission request acknowledgement transmitted from the second relay node, delete the un-transmitted divided data that has not been transmitted to the transmission destination node.

3. The network system according to claim 1, wherein
the third processor is further configured to:
save the at least one piece of redundant data in a buffer included in the third memory; and
transmit remaining redundant data that has not been saved, in the second direction round, and
an amount of the saved at least one piece of redundant data is equal to a free capacity of the buffer.

4. The network system according to claim 1, further comprising the transmission destination node, wherein
the transmission destination node includes:
a fourth memory; and
a fourth processor coupled to the fourth memory and the fourth processor configured to:
when the un-transmitted redundant data is not saved in any node in the ring network except for the transmission source node and the transmission destination node and the transmission request is transmitted to the transmission destination node, transmit a transmission request acknowledgement toward the transmission source node, and
the first processor is further configured to:
when receiving the transmission request acknowledgement transmitted from the transmission destination node, transmit the un-transmitted divided data in the second direction round toward the transmission destination node.

5. The network system according to claim 1, wherein
the fourth processor is further configured to:
when receiving the transmission target data, transmit a data reception completion notification in the first direction round and the second direction round, and
the third processor is further configured to:
when receiving the data reception completion notification, delete the saved redundant data corresponding to the data reception completion notification.

6. The network system according to claim 1, wherein
the first processor is further configured to:
transmit a part of the divided transmission data as the plurality of pieces of divided data in the first direction round; and transmits a rest of the divided transmission data as a plurality of other pieces of divided data in the second direction round.

7. The network system according to claim 6, wherein
the first processor is further configured to:
determine a number of pieces of data to be transmitted in the first direction round and a number of pieces of data to be transmitted in the second direction round among the divided transmission data, based on a ratio between a load on a path to the transmission destination node in the first direction round and a load on a path to the transmission destination node in the second direction round.

8. A non-transitory computer-readable recording medium storing a program for causing a computer as a node among nodes that form a ring network that includes a transmission source node, a first relay node, and a second relay node, to execute a communication control process, the communication control process comprising:
executing a first process as the transmission source node, the first process including:
dividing transmission target data to be transmitted to a transmission destination node included in the ring network into a plurality of pieces of divided data;
transmitting the plurality of pieces of divided data in a first direction round of the ring network; and
transmitting a plurality of pieces of redundant data, each of which corresponds to one of the plurality of pieces of divided data, in a second direction round opposite to the first direction round;
executing a second process as the first relay node, the second process including:
detecting occurrence of a failure in a path to the transmission destination node in the ring network; and
when there is un-transmitted divided data that has not been transmitted to the transmission destination node among the plurality of pieces of divided data received from the transmission source node, transmitting a transmission request for un-transmitted redundant data that corresponds to the un-transmitted divided data among the plurality of pieces of redundant data, in the second direction round; and
executing a third process as the second relay node, the third process including:
saving at least one piece of redundant data among the plurality of pieces of redundant data received from the transmission source node in a memory;
receiving the transmission request; and
when the un-transmitted redundant data corresponding to the transmission request is saved in the memory, transmitting the un-transmitted redundant data in the second direction round toward the transmission destination node.

9. A communication control method executed by a computer as a node among nodes that form a ring network that includes a transmission source node, a first relay node, and a second relay node, the communication control method comprising:
executing, by the computer, a first process as the transmission source node, the first process including:
dividing transmission target data to be transmitted to a transmission destination node included in the ring network into a plurality of pieces of divided data;
transmitting the plurality of pieces of divided data in a first direction round of the ring network; and
transmitting a plurality of pieces of redundant data, each of which corresponds to one of the plurality of pieces of divided data, in a second direction round opposite to the first direction round;
executing, by the computer, a second process as the first relay node, the second process including:
detecting occurrence of a failure in a path to the transmission destination node in the ring network; and
when there is un-transmitted divided data that has not been transmitted to the transmission destination node among the plurality of pieces of divided data received from the transmission source node, transmitting a transmission request for un-transmitted redundant data that corresponds to the un-transmitted divided data among the plurality of pieces of redundant data, in the second direction round; and
executing, by the computer, a third process as the second relay node, the third process including:
saving at least one piece of redundant data among the plurality of pieces of redundant data received from the transmission source node in a memory;
receiving the transmission request; and
when the un-transmitted redundant data corresponding to the transmission request is saved in the memory, transmitting the un-transmitted redundant data in the second direction round toward the transmission destination node.
